(19) United States
(12) Patent Application Publication
(10) Pub. No.: US 2010/0061415 A1
(43) Pub. Date: Mar. 11, 2010

(54) OPTICAL FIBRE MATERIAL COMPRISING SILICA-BASED GLASS WITH REDUCED PHOTO DARKENING

(75) Inventor: Kent Erik Mattsson, Virum (DK)

Correspondence Address: BUCHANAN, INGERSOLL & ROONEY PC, POST OFFICE BOX 1404, ALEXANDRIA, VA, 22313-1404, US

(73) Assignee: Crystal Fibre A/S, Birkerod (DK)

(21) Appl. No.: 12/515,662

(22) PCT Filed: Nov. 20, 2007
(86) PCT No.: PCT/DK2007/000509

§ 371 Date: May 20, 2009

Related U.S. Application Data
(60) Provisional application No. 60/859,950, filed on Nov. 20, 2006.

(30) Foreign Application Priority Data
Nov. 20, 2006 (DK) PA 2006 01516

(51) Int. Cl. H01S 3/17; H01S 3/067; H01S 3/16

(52) U.S. Cl. 372/40; 372/66; 372/41

(57) ABSTRACT

The invention relates to a waveguide laser or amplifier material comprising a silica glass host material, one or more rare earth elements in total concentration CRE at. %, one or more network modifier elements selected from the group of tri- or penta-valent atoms of the periodic table of the elements in total concentration CNME at. %, wherein the ratio of atomic concentrations of the modifier elements to that of the rare earth elements CNWCRE is larger than or equal to 1, and wherein the total atomic concentration of rare earth and the tri-valent network modifiers, such as aluminium and/or boron, is substantially equal to the atomic concentration of the penta-valent network modifier, such as phosphorous. Such materials exhibit reduced risk of photo darkening.

### TECHNICAL FIELD OF THE INVENTION

The invention relates to the field of high power light amplification in rare earth doped glass material pumped resonant with the rare earth absorption bands. In particular, this invention relates to reduce photo darkening in rare earth doped optical amplifier silica glass material by choice of silica glass material composition.

### BACKGROUND OF THE INVENTION

High power optical fibre lasers and amplifiers are becoming of increasing interest at least partly due to their efficiency, lower cost, and the availability of suitable high power pump sources, such as arrays of high power diode pump lasers. Such arrays of diode pump lasers can have an output power of several hundred watts or greater, and serve as ideal pump sources for optical fibre lasers. In combination with a high power pump source at least one aspect of the function of the optical fibre amplifier/laser could said to be the conversion of the highly multi-mode output from a diode array to a high power single mode output of a power amplifier or laser. The fibre converts the multimode, high power, low brightness diode array to a high brightness, substantially single mode source. There are many situations in which the beam quality of a single mode fibre with less power is more desirable than a higher powered multi-mode array. These applications comprise materials processing (cutting, welding, and marking) and surgery.

Using diode bar arrays as one example of a suitable multimode high power pump source, such bar arrays may be arranged to produce power levels in the many hundred of watts range. The power is delivered through multi-mode fibres, or arrays of fibres bundled together. As single mode operation is desired for high brightness one challenge is the coupling of the multimode light to the single mode core which is commonly small (5-100 μm in diameter) and commonly with a small numeric aperture. The brightness theorem specifies that the numerical aperture of the fibres coming from the diode sources, times the fibre area, must be a constant. Thus, the high intensity light from the fibre output of the diode array cannot be focused into the core of a standard single mode fibre. To circumvent this problem the double clad fibre construction may be applied. Here a high numeric aperture cladding region surrounding a core region is constructed to accept the pump power whereas the RE (e.g. ytterbium) doped core region with a low numeric aperture typically constitutes a central region of the double clad fibre. Hereby the multimode diode, low brightness light is effectively brought in overlap with the ytterbium doped core material in which high power single mode light is generated through stimulated emission e.g. inside a laser cavity consisting of two fibre gratings constructed either directly in the ytterbium doped fibre or in a separate fibre spliced to the ytterbium doped fibre.

Due to the relative small diameter of the core, the optical flux, i.e. the optical lasing power and/or pumping power transmitted per unit area of the fibre core, is extremely high. Consequently, absorption effects in the core and/or at features such as a gratings in the core, referred to as photo darkening, may result in unwanted degradation of the device within a time frame which is often substantially shorter than the lifetime required for the respective application of such lasers. In one instance it has been observed experimentally that with constant pump power, the lasing output decreased by several percent during a 1000 hours time period. It has further been observed experimentally that considerable increase in propagation loss may be measured in un-seeded amplifiers after only a few hours of operation. In this regard it should be noted that the double clad fibre, the fibre amplifier and the fibre laser are merely examples where a material comprising active dopants is potentially exposed to high optical intensity sufficient to potentially induce photo darkening.

In the literature photo darkening of ytterbium and other rare earth doped silica materials has been attributed to the formation of colour centres in the glass material. The exact factor responsible for the increased absorption has not been identified but it may be observed when irradiating the glass material with high energy photons (such as UV-, x- or γ-rays) or resonant photons within the absorption bands of rare earth material.

In connection with Thulium co-doped silicate fibres photo darkening has been observed by Brocklesby et al. (Optics Letters, Vol. 18, No. 24, (1993)) that the fibre material photo darkens when irradiated with (476 nm) radiation resonant with the Thulium absorption band. Here it was shown that the photo darkened material can partly be recovered by irradiating with non-resonant radiation at 514 nm or when heating the fibre at temperatures>350° C. For Terbium co-doped silicate fibres, 488 nm resonant radiation is by Atkins et al. (Optics Letters, Vol. 19, No. 13, (1994)) observed to photo darken the fibre material, whereas bleaching can be performed with non resonant radiation 514 nm laser line of an argon ion laser.

For ytterbium co-doped silicate fibres Gavrilovic et al. (U.S. Pat. No. 6,154,598) claims that photo darkening is due to unintentionally incorporated impurities disposed in the lasing medium, which up-convert a portion of the lasing radiation to radiation of shorter wavelength, thereby introducing defects in the medium which result in increased absorption due to photo darkening.

In U.S. Pat. No. 4,830,463 it is by Lemaire et al. described how fused silica doped with approximately equimolar amounts of Al and P hold a refractive index that is lower than, or at least not significantly greater than, that of pure fused silica, even though both Al and P individually are known up-dopants for silica referring to the refractive index increasing with added Al or P. The refractive index decreasing effect of phosphorous on aluminium in combination with rare earth doping is not mentioned by Lemaire et al.

In U.S. Pat. No. 5,937,134, a silica glass material containing rare earth, germanium, aluminium and phosphorous is described, which hold a refractive index rise less than 0.008. Photo darkening of such materials are not described, neither is the combined effect on the material refractive index of a silica material comprising aluminium, phosphorous and rare earth.

It is often difficult to predict how a particular fibre glass material will perform under a given set of operating conditions and further difficult to choose a proper glass material composition for fibres intended for high power amplification.

### SUMMARY OF THE INVENTION

It is an object the invention to provide optical active material, referred to as a waveguide laser and amplifier material, with low risk of photo darkening is provided, preferably in form of optical waveguide or optical fibre structures, wherein the lasing or amplifier output power level at constant pump power, of a laser and/or amplifier comprising said material, is maintained substantially constant over an extended operating period.

In an embodiment of the invention the photo darkening precursors in the waveguide laser and amplifier material are reduced.

In an embodiment of the invention the photo darkening precursors in the waveguide laser and amplifier material is reduced while providing a refractive index of the material substantially equal to the refractive index of fused silica glass.

In a preferred embodiment of the invention the reduction of photo darkening precursors in the waveguide laser and amplifier material, is attained by appropriately choosing the concentration of network modifiers in the silica glass material relative to the rare earth doping concentration. This is preferably obtained while minimizing the effect on the refractive index of the material. In one embodiment, the refractive index of the glass material substantially equal to the refractive index of fused silica glass. It is believed that the composition/ratio between rare earth (RE) atoms and other network modifiers (such as e.g. aluminium, phosphor, boron) determines the amount of RE-RE pairs (e.g. ytterbium-ytterbium pairs) inside the glass material and hereby the inherent generation of co-operative frequency up-converted light produced.

The network, modifier atoms for use in silica host glasses are preferably selected from the group of tri- or pentavalent atoms, such as e.g. aluminium, phosphor, boron, etc. This may result in a reduced tendency of the glass material to devitrify.

The network modifier atoms are preferably added to the glass to counteract devitrification when the concentration of rare earth atoms is increased such as above approximately 0.01 at %. It is speculated that an additional effect of the network modifiers is that when sufficient amount of these are present the concentration of rare earth pairs decreases with a reduction in the co-operative frequency up-conversion as a result. The co-operative frequency up-conversion is unwanted as it is ascribed to reduce the amplification efficiency of the glass material. An additional effect of the addition of network modifiers (NM) is, for example for ytterbium, that the concentration of Yb—Al—Yb atom strings is reduced with increasing Al concentration or alternatively for the corresponding Yb-NM-Yb strings with increasing phosphor or boron concentration. The denotation ‘Yb—Al—Yb atom string’ is to be taken as an abbreviation for Yb—O—Al—O—Yb. In the generalized form ‘RE-NM-RE atom string’ is to be taken as an abbreviation for RE-O-NM-O-RE. I.e. the rare earth atom is connected to the network modifier atom through an oxygen atom. It is believed that the RE-NM-RE atom strings are the main suppliers of electrons to lone-electron pair colour centres established near non-binding oxygen sites due to the large absorption cross section of rare earth when pumped resonant. The RE-NM-RE atom strings is believed to initiate the formation of paired- or empty non-binding oxygen sites. A similar function is assumed for RE-NM-NM atom strings. It is, however, only at high population inversion that the contribution in formation of paired- or empty non-binding oxygen sites by RE-NM-NM strings is believed to be of significance. At low population inversion the photo darkening of the material is dominated by the RE-NM-RE atom strings. Low population inversion is found when stimulated feedback is given to the glass material (such as when operating the material in a laser setup or for an amplifier with relative high input signal). The role of NM-NM-NM chains is believed to be negligible due to a much smaller absorption cross section when pumped resonant with the RE (e.g. ytterbium) absorption band.

The photo darkening precursors are believed to be the empty non-binding oxygen sites next to NM atoms. These non-binding oxygen sites are likely created when silica containing network modifiers in substitute Si⁴⁺ sites is subjected to radiation resonant with the rare earth atoms. It is speculated that photo darkening may be observed when an electron is shifted from a network modifier atom site by the action of either a signal or a pump photon to a nearby positively charged non-binding oxygen site. It is believed that due to the Coloumb field between the NM and O atoms, there exist an infinite number of energy states up to the ionization energy of the electron which gives rise to the very broad absorption bands for various non-binding oxygen sites (dependent on the actual charge of the site and the NM atom involved) that can be observed in photo darkened material.

It is believed that the addition of network modifiers to silica glass material will lead to formation of non-binding oxygen sites which are the precursors for photo darkening. One way to avoid formation of non-binding oxygen sites is through addition of hydrogen to the glass material. This may be achieved through addition of phosphorous to the glass material because phosphorous hold high affinity for hydrogen that automatically follows phosphorous. This is discussed in further detail in the published PCT application WO2007/110081 which is hereby incorporated in its entirety. However, one drawback of this approach is that addition of large amount of network modifiers such as phosphor and aluminium individually into the silica glass matrix will often lead to significant increase in the refractive index of the glass material rendering this material limited in its suitability as core of a single mode waveguide laser/amplifier as the core diameter must be reduced with an increased refractive index. Coupling between a small core and a standard fibre core may be difficult and a small cores will be more susceptible to non-linear effects. It has been realized by the present inventor through modelling that adding substantially equal amounts of penta-valent NM (e.g. phosphor) to the sum of the amounts of tri-valent NM (e.g. aluminium and/or boron) and RE (e.g. ytterbium) leads to a material that holds a refractive index that is substantially less than the index-modifying effect of the individual ingredients taken alone. This allows the core diameter of the fibre laser to be increased significantly, while still being able to sustain light at the operating wavelength in a substantially single mode and simultaneously apply a waveguide laser and amplifier material with a significantly reduced number of photo darkening precursors.

In some embodiments of the invention core glass composition for a fibre laser allows relative large amounts of mixed network modifiers to be incorporated into the core glass material with a combined effect on the core refractive index that is substantially less than the index-modifying effect of the individual network modifiers taken alone. This allows the core diameter of the fibre laser to be increased significantly. In one embodiment this obtained by using phosphorous as a counter doping to offset the index-modifying effect of aluminium and/or boron and rare earth atoms.

### DISCLOSURE OF INVENTION

Objects of the invention are achieved by the invention described in the accompanying claims and as described in the following.

One embodiment of the invention is an optical amplifier comprising a diode bar array pump laser, which operates at a wavelength λₚᵤₘₚ and with a pump power exceeding 5 W, a coupling device, a silica host glass fibre with a rare earth doped core co-doped with network modifiers aluminium and/or boron and phosphor in a concentration such that the total atomic network modifier concentration is at least 5 times (such as at least 6 or at least 7 times) the rare earth atomic concentration and wherein the atomic concentration of phosphorous substantially equals the sum of rare earth atomic concentration and aluminium and/or boron atomic concentration, and an output delivery fibre, wherein the wavelength λₚᵤₘₚ is resonant with said rare earth doping absorption band.

An advantage of this embodiment is that the concentration of rare earth atoms in chains with network modifiers, wherein more than one rare earth atom is present, is reduced when the network modifier concentration is increased. This expected to reduce the photo darkening steady state concentration of non-binding oxygen colour centres. The advantageous choice of equal atomic concentrations of phosphorous and atomic concentration of the sum of rare earth and aluminium and/or boron leads to a silica glass material with a refractive index that is substantially equal to the refractive index of fused silica.

In an embodiment of the invention the optical amplifier is a high power optical amplifier.

In an embodiment of the invention, it is possible to optimize the amplification of the glass material in its gain bandwidth by pumping the RE doped glass with radiation resonant with the RE absorption, such as optimizing amplification in the 976 nm-1150 nm band by pumping ytterbium doped glass with radiation resonant with the ytterbium absorption band (880 nm-976 nm). An increased amplification may be reached by increasing the RE atomic concentration above 0.1 atomic percent, such as above 0.2 atomic percent, such as above 0.3 atomic percent, such as above 0.5 atomic percent, such as above 1.0 atomic percent.

To reduce the number of co-operative frequency up-converting RE-RE atom pairs, an addition of network modifiers, such as aluminium (and/or boron) and phosphorous in a concentration at least 7 times the rare earth atomic concentration, such as at least 8 times the rare earth atomic concentration, such as at least 10 times the rare earth atomic concentration, such as at least 12 times the rare earth atomic concentration, such as at least 14 times the rare earth atomic concentration, may be advantageous.

In an embodiment of the invention the silica host glass, preferably a fibre, is advantageously configured as a double clad fibre with a core diameter d_{core}>4 μm with a numeric aperture less than 0.1, and a first cladding diameter>30 μm with a numeric aperture larger than or equal to 0.4, surrounded by a second cladding preferably either polymeric material, glass or an air/glass microstructure (e.g. in the form of a so-called air-cladding). In a one embodiment said coupling device is a fused fibre bundle tapered to fit in numeric aperture to the numeric aperture of the first cladding and the fibre bundle fibres attached to diode bar array lasers.

In one embodiment the optical amplifier is configured such that between the coupling device and the silica host glass fibre a first reflecting element (e.g. a fibre Bragg grating) is formed, and wherein between the silica host glass fibre and the output delivery fibre a second reflecting element (e.g. a fibre Bragg grating) is formed so that laser operation of optical amplifier may be achieved. In one embodiment these gratings can be either formed by fusion splicing a section of fibre wherein the fibre Bragg grating is formed to the respective fibre ends or be written directly into the rare earth doped core. The latter optic requires that germanium doped areas are formed next to the core glass material within or next to the fibre core. In principle any type of laser configurations may be incorporated into the optical amplifier such as cavity laser as well as ring laser. Examples of such designs are a Q-switched laser and a mode-locked laser, such as via a SESAM. These configurations may be all-fibre configurations or semi-bulk configurations wherein some part of the laser cavity comprises bulk optic elements. Finally, the optical amplifier may also be incorporated in non-fibre waveguides.

In embodiments of the invention, the silica host glass fibre is a non-micro-structured fibre (comprising a doped core region surrounded by a (e.g. down-doped) cladding region) or a micro-structured fibre (comprising a doped core region surrounded by a cladding region comprising an air-cladding and/or a region comprising a (regular or irregular) pattern of longitudinally extending micro-structural elements, either in the form of voids, liquid filled or solid (e.g. low-index) elements. In an embodiment of the invention, the silica host glass fibre is a multi cladding fibre comprising a core region for propagating and amplifying signal light and a cladding region adapted for propagating pump light for excitation of the RE-material in the core region. In an embodiment, the optical fibre is adapted to propagate the signal light in the core region substantially in a single mode, e.g. over an extended wavelength range. In an embodiment, the multi cladding fibre comprises an air-cladding for confining the pump light of an inner cladding region, the inner cladding may or may not comprise further micro-structural elements. Various aspects of the fabrication and properties of micro-structured optical fibres are discussed in Bjarklev, Broeng, and Bjarklev in “Photonic crystal fibres”, Kluwer Academic Press, 2003, chapter 1 and 4.

When used in the present application in connection with a power amplifier, the term ‘core’ is taken to mean the part of the waveguide, commonly embodied as an optical silica host glass fibre, that carries a signal intended to be amplified by the amplifier or laser it forms part of The core is typically centrally located in the waveguide.

The term ‘substantially equal’ applied in relation to concentration, such as atomic concentration, is intended to mean within 5% of each other, e.g. so that the ratio of the difference between the larger value and the smaller value to the larger value is smaller than or equal to 10%, such as ≦5%, such as ≦2%, such as ≦1%.

The term ‘the wavelength λₚᵤₘₚ is resonant with the rare earth doping absorption band’ is in the present context taken to mean that the wavelength λₚᵤₘₚ is to be found within the pump absorption band of the particular rare earth element involved.

The rare earth dopant may in general comprise one or more of the rare earth elements of the periodic table of elements, comprising Nd, Tb, Dy, Ho, Er, Tm, Yb. In a particular embodiment, the rare earth dopant comprises Yb (ytterbium).

A silica host glass is a glass wherein the primary component is SiO₂.

Throughout this text the term amplifier is taken to mean an optical amplifier unless otherwise clear. Furthermore, the terms amplifier and laser are used interchangeably unless otherwise clear as the amplifier may function as the gain medium of a laser.

Throughout this text the terms at %, at. % and atomic concentration are used interchangeably. Also the terms atoms and elements are used interchangeably as well as these terms may be omitted, such as in network modifier, network modifier atom, and network modifier element.

In an embodiment of the invention, a waveguide laser or amplifier material is provided, the material comprising
a silica glass host material,
one or more rare earth elements in total concentration c_{RE} at. % (mol.),
one or more network modifier elements selected from the group of tri- or penta-valent atoms of the periodic table of the elements in total concentration c_{NME} at. % (mol.),

wherein the ratio of atomic concentrations of the modifier elements to that of the rare earth elements C_{NME}/C_{RE} is larger than 5, and wherein the total atomic concentration of rare earth and the tri-valent network modifiers, such as aluminium and/or boron, is substantially equal to the atomic concentration of the penta-valent network modifier, such as phosphorous.

In particular embodiments, the ratio c_{NME}/C_{RE} is larger than 6, such as larger than 7, such as larger than 8, such as larger than 9, such as larger than 10, such as larger than 12, such as larger than 14, such as larger than 20.

In particular embodiments, the network modifier elements are selected from the group of elements comprising aluminium, phosphor, boron, and combinations thereof. In the present context, aluminium and boron are assumed to be tri-valent and phosphor penta-valent.

In particular embodiments, the rare earth doped material comprises elements selected from the group consisting of Tb, Nd, Ho, Dy, Tm, Er and Yb and combinations thereof.

In a particular embodiment, the rare earth doped material is ytterbium.

In particular embodiments, the material further comprises fluorine in concentration c_{F} at. % (moo), such as c_{F}≧c_{RE}.

In an embodiment of the invention, a preform for fabricating an optical fibre comprising a waveguide laser or amplifier material as described above, in the detailed description and in the accompanying claims is provided.

In an embodiment of the invention, an optical fibre comprising a waveguide laser or amplifier material as described above, in the detailed description and in the accompanying claims is provided.

In discussing the properties of the optical fibre this term is used as an example of a general optical waveguide unless otherwise clear. As a person skilled in the art will realize most features presented in relation to an optical fibre may also be applied mutatis mutandis to other types of optical waveguides such as a planar waveguide. In this case minor adjustments may apply such that the cladding surrounding the core in a planer waveguide normally comprises a top cladding and a substrate. In the case of waveguides other than an optical fibre, the term cladding region is taken to mean the material(s) immediately adjacent to the core region and/or cladding region which it is specified to enclose and/or surround. Accordingly, in one embodiment of the invention is an optical waveguide comprising a waveguide laser or amplifier material as described above.

In a particular embodiment, the optical fibre comprises a core region surrounded by two or more cladding regions wherein at least one of said core and cladding regions comprises said waveguide laser or amplifier material and is adapted to guide light at a signal wavelength. The signal wavelength is often the wavelength of the light to be amplified or by which a laser is meant to lase.

In a particular embodiment, at least one of said core and cladding regions is adapted to guide light at a pump wavelength. The pump wavelength is often the wavelength of the pump light source(s) by which the optical fibre is designed to function with.

In an embodiment, the optical fibre is adapted to propagate the signal light in the core region substantially in a single mode, e.g. over an extended wavelength range.

In a particular embodiment, the optical fibre comprises micro-structural elements in one or more of the core and/or cladding regions. Alternatively, the optical fibre can be a standard (non-micro-structured, all solid) optical fibre.

In a particular embodiment, the optical fibre comprises an air-clad region for confining light within it.

In a particular embodiment, the optical fibre comprises a polymer cladding region.

In a particular embodiment, the core region has a maximum cross-sectional dimension larger than 4 μm, such as larger than 10 μm, such as larger than 20 μm, such as larger than 50 μm, such as larger than 100 μm. In a particular embodiment, a first inner cladding region located adjacent to the core region has a numeric aperture larger than or equal to 0.4, such as larger than 0.45, such as larger than 0.5, such as larger than 0.55.

In an embodiment of the invention an optical amplifier comprises:
a) An optical waveguide according optical fibre or optical waveguide as described above, in the detailed description and in the accompanying claims is provided,
b) at least one pump laser which is operating at one or more a wavelengths λₚᵤₘₚ with a total pump power equal to or exceeding 5 W arranged to pump said optical waveguide wherein the wavelengths λₚᵤₘₚ are resonant with said rare earth doping absorption band, and
c) an output

Naturally, an amplifier according to this embodiment may further comprise any of the features of the optical amplifier discussed above as specified in the accompanying set of claims.

In an embodiment of the invention, an article, e.g. in the form of a fibre laser or amplifier comprises an optical fibre or optical waveguide as described above, in the detailed description and in the accompanying claims is provided.

In an embodiment, the article comprises a source of pump light comprising wavelengths that are resonant with an absorption band of said one or more rare earth elements.

In an embodiment, the pump light comprises wavelengths below 1000 nm, such as between 850 nm and 1000 nm, such as between 910 nm and 976 nm.

In an embodiment, the article is adapted to operate at a wavelength below 1100 nm.

In an embodiment, the input power to output power efficiency degradation after 1000 hours of operation at a population inversion level of 15% is less than 10%, such as less than 5%, such as less than 2%, such as less than 1%.

In an embodiment of the invention, use of an article as described above, in the detailed description and in the accompanying claims at an operating wavelength below 1100 nm, such as between 900 nm and 1100 nm is provided.

### BRIEF DESCRIPTION OF THE DRAWINGS

In the following, the invention will be explained in more detail for a preferred embodiment and with reference to the drawings in which

FIG. 1 shows a diagram of the optical amplifier according to the present invention;

FIG. 2 shows a diagram of the optical amplifier according to the present invention in a laser configuration;

FIG. 3 shows an end view of the double cladding fibre in the optical amplifier device of FIG. 1 or the laser configuration of FIG. 2.

The figures are schematic and details may be omitted for clarity. Throughout, the same reference numerals are used for identical or corresponding parts.

### MODE(S) OF CARRYING OUT THE INVENTION

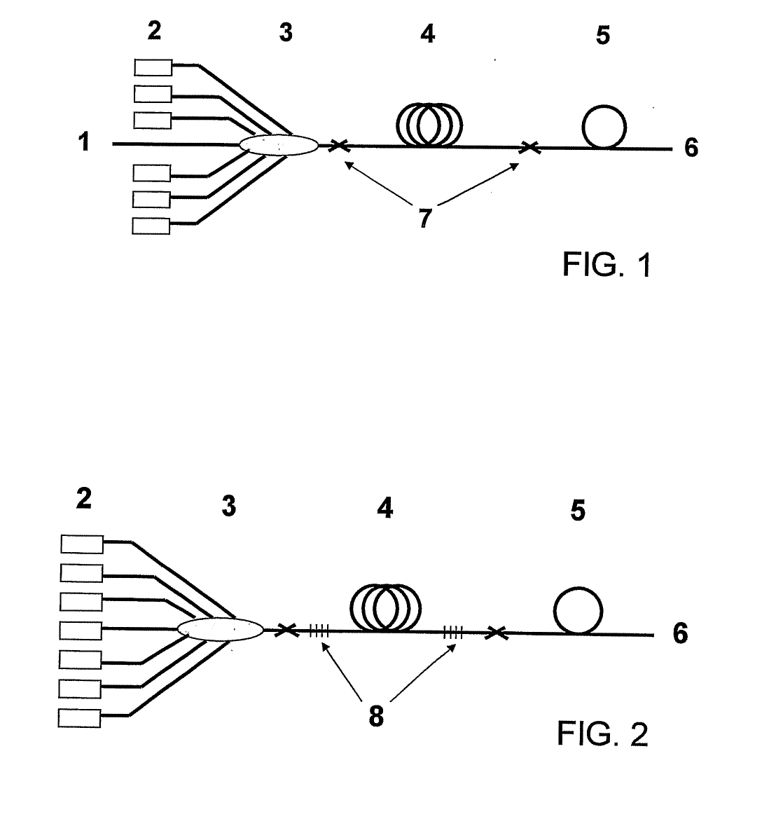

FIG. 1 shows a schematic diagram of an optical amplifier according to one embodiment of the present invention. The input signal 1 is amplified through the optical amplifier and delivered as output 6 from the output delivery fibre 5. The pump radiation from diode bar arrays 2 is coupled into a silica host glass fibre, here a double cladding fibre 4 through a coupling device, here a section of fused and tapered fibre bundle 3, tapered to fit the bundle output numeric aperture to the numeric aperture of the inner cladding of the double cladding fibre 4. The signal radiation 2 is coupled into the centre core of the double cladding fibre by the same tapered fibre bundle 3. The output signal is delivered by output fibre 5 to the output 6 in a substantially single mode core. The coupling device or fused and tapered fibre bundle is fusion spliced to the double cladding fibre as is the output delivery fibre as indicated with crosses 7. Diode bars are currently available from a large number of different suppliers such as Bookham (San José, Calif., USA), OSRAM Opto Semiconductors (Regensburg, Germany) and JDSU (Milpitas, Calif., USA). Tapered fibre bundles 3 are e.g. described in U.S. Pat. No. 5,864,644 (e.g. FIG. 1) and WO 2005/091029 (e.g. FIG. 16). In one embodiment the double clad 4 fibre is a micro-structured fibre, such as an air-clad fibre. This has the advantage of providing a fibre that is suitable for high-power applications. In the present context, the term an ‘air-clad’ fibre is taken to mean a micro-structured fibre wherein light to be propagated is, at least mainly, confined to a part of the fibre within a circumferential distribution of longitudinally extending voids in the cladding of the fibre, cf. e.g. U.S. Pat. No. 5,907,652 or WO-03/019257. An example of such a fibre (without the material modifications of the present invention) is a DC-225-22-Yb fibre from Crystal Fibre A/S (Birkeroed, Denmark). Various aspects of the splicing of micro-structured optical fibres are e.g. discussed in WO 2004/049025.

FIG. 2 shows a schematic outline of an optical amplifier according to an embodiment of the present invention in a laser configuration. The input signal port (1 in FIG. 1) is in this setup replaced by a pump diode fibre connected to a diode of the diode bar array 2. The laser action is achieved by adding reflecting elements (here gratings) in or next to the amplifier as indicated by 8. Other components shown in FIG. 2 are equivalent to those shown in FIG. 1 and discussed above. Aspects of rare-earth doped silica fibre lasers are described in a variety of sources, e.g. in Michel. J. F. Digonnet, “Rare-Earth-Doped Fiber Lasers and Amplifiers”, 2^{nd} edition, 2001, Marcel Dekker, Inc., chapter 3, pp. 113-170.

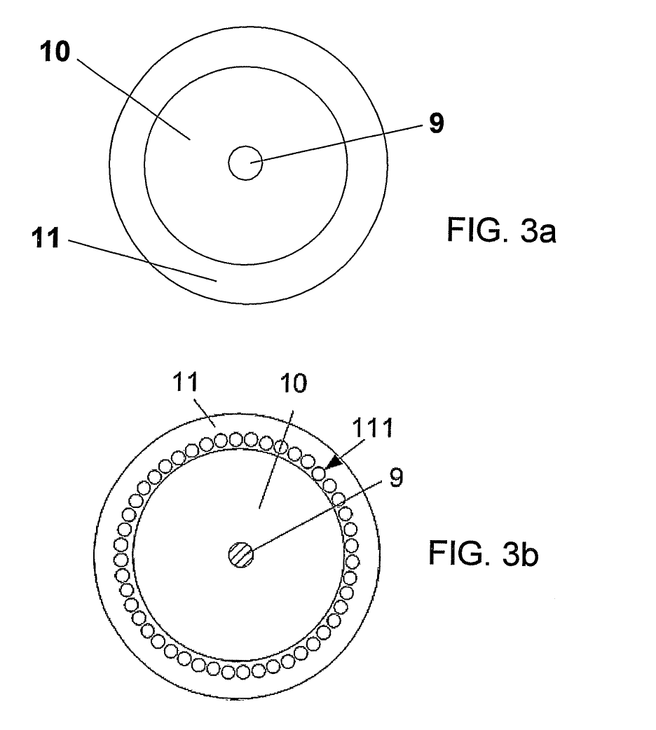

FIG. 3 shows a schematic end view of one embodiment of a double cladding fibre 4 in the optical amplifier device of FIG. 1 or the double cladding fibre 4 in the laser configuration of FIG. 2. The view of FIG. 3 is representative of a cross section taken at any position along the fibre. The double cladding fibre comprises a core 9, a first cladding 10, and a second cladding 11. The fibre is shown with a circular cross section but may be non-circular, such as slightly elliptical, to allow mode coupling. The core of the fibre has a composition in accordance with the invention as will be described below. The first cladding layer 10 may in principle be any suitable material preferably a high purity silica material, preferably pure fused silica but at least 85% SiO₂. In one embodiment, the first cladding layer may include doping such as germanium, aluminium, phosphorous or flour, to control the refractive index of the cladding and induce an index contrast between the core and first cladding. FIG. 3a illustrates an all solid (non-micro-structured) embodiment. In another embodiment of the current invention (as shown in FIG. 3b), the first cladding layer includes an air/glass microstructure 111 to achieve this purpose. In one embodiment, the second cladding 11 comprises either a solid (e.g. of polymeric material) or an air/glass microstructure with a numeric aperture that preferably fits the numeric aperture of the first cladding to the numeric aperture of the coupling device such as a fibre bundle fibres attached to a diode bar array lasers.

The second cladding is preferably surrounded by further cladding regions/cladding material, e.g. relatively impure SiO₂ derived from a silica substrate or overcladding tube (cf. FIG. 3b where an overcladding around the air clad 111 is indicated), that essentially does not play any part in the guidance of the radiation but serves to provide bulk and mechanical strength to the fibre.

In the following, the dimensioning and application of the optical amplifier silica glass material will be discussed in connection with a number of examples.

### EXAMPLE 1

This example illustrates how the concentrations of RE and network modifiers could be selected according to the invention. In this example the photo darkening of optical amplifier silica glass host material doped with ytterbium is reduced by adding network modifiers to the glass matrix in a rare earth to network modifier ratio of 1:7.

The ytterbium concentration chosen is such that the ytterbium doped silica glass material holds approximately 1600 dB/m pump absorption at 976 nm. This corresponds to 0.33 atomic percent ytterbium in the silica glass material. Adding equal amounts of ytterbium and aluminium to phosphorus leads to the equation:

0.33 at % Yb+X at % Al=Y at % P

It is further required that the ratio between network modifiers and ytterbium is 7. This leads to the equation: 7·0.33 at % Yb=X at % Al+Y at % P. The two equations with two unknown are solved: X=1.0 at % Al and Y=1.3 at % P. The inventive material comprises hereby:

0.33 at % Yb; 1.0 at % Al, 1.3 at % P, 30.7 at % Si and 66.7 at % O

The refractive index rise relative to the refractive index of fused silica by this material is expected to be below 0.002. The amount of ytterbium-ytterbium pairs exhibiting unwanted co-operative frequency up-conversion is expected to be below 5%.

### EXAMPLE 2

This example illustrates how the concentrations of RE and network modifiers could be selected according to the invention. In this example the photo darkening of optical amplifier silica glass host material doped with ytterbium is reduced by adding network modifiers to the glass matrix in a rare earth to network modifier ratio of 1:10.

The ytterbium concentration chosen is such that the ytterbium doped silica glass material holds approximately 1600 dB/m pump absorption at 976 nm. This corresponds to 0.33 atomic percent ytterbium in the silica glass material. Adding equal amounts of ytterbium and aluminium to phosphorus leads to the equation:

0.33 at % Yb+X at % Al=Y at % P

It is further required that the ratio between network modifiers and ytterbium is 10. This leads to the equation: 10·0.33 at % Yb=X at % Al+Y at % P. The two equations with two unknown are solved: X=1.49 at % Al and Y=1.82 at % P. The inventive material comprises hereby:

0.33 at % Yb; 1.49 at % Al, 1.82 at % P, 29.7 at % Si and 66.7 at % O

The refractive index rise relative to the refractive index of fused silica by this material is expected to be below 0.004. The amount of ytterbium-ytterbium pairs exhibiting unwanted co-operative frequency up-conversion is expected to be below 2%.

The atomic density (atoms/unit volume, e.g. atoms/cm³) of the different elements in a given sample may e.g. be determined by Secondary Ion Mass Spectrometry (SIMS) measurement or by an energy-dispersive X-ray analysis (EDX) measurement. The basic principles of both techniques are discussed extensively in various textbooks, see e.g. “Fundamentals of surface and thin film analysis”, L. C. Feldman, J. W. Mayer, ISBN 0-444-00989-2, wherein—for example—quantitative analysis down to an accuracy of about 1% by EDX is discussed. EDX is characterized by being a surface sensitive tool with electron penetration depths between 5 and 100 Å, depending on the energy of the incoming electron. A connection between atomic concentration and relative molar concentration may be estimated by assuming or measuring a certain mass density of the resulting material (H may optionally be neglected due to its small contribution to the mass density). The atomic density Nₐₜ for a given element Q (Q=Si, O, P, B, Al, Yb, Tb, Nd, Ho, Dy, Tm, Er) is given by the formula (using Yb as an example of the RE dopant):

Nₐₜ(Q)=c(Q)·ρ(SiOPAlYb)·Nₐ/Mₜₒₜ

where c(Q), as mentioned above, is the relative concentration of the element Q in the example SiOPAlYb material composition, Nₐ is Avogadro's number (the number of atoms or molecules in a mole) and Mₜₒₜ=a·M_{Si}+b·M_{O}+c·M_{P}+d·M_{Al}+e·M_{Yb} is the mole mass (unit mass/mole, e.g. g/mole) of the SiₐO_{b}P_{c}Al_{d}YbₑHₓ material, where M_{Q} is the atomic mass of element Q. (e.g. M_{Si}=28.086 g/mole).

In an embodiment, the glass material exhibits an input pump power to output power efficiency degradation less than 10% degradation during 1000 hours of operation at a population inversion level above 15%, such as degradation less than 5%, such as less than 2%, such as less than 1%.

Photo darkening is observable as increased absorption at wavelengths in the 400 nm-1100 nm range. The photo darkening is observable through growing absorption with peaks near 400 nm wavelength (3.0 eV±0.65 eV) and 530-550 nm (2.3 eV±0.85 eV).

### REFERENCES

Brocklesby et al. Defect production in silica fibers doped with Tm³⁺. Optics Letters, Vol. 18, No. 24, 1993, pp. 2105-2108
Atkins et al. Photodarkening in Tb³⁺-doped phosphosilica and germanosilicate optical fibers. Optics Letters, Vol. 19, No. 13, 1994, pp. 874-877
U.S. Pat. No. 6,154,598 (Polaroid) Nov. 28, 2000
U.S. Pat. No. 4,830,463 (AT&T) May 16, 1989
U.S. Pat. No. 5,937,134 (Lucent Technologies) Aug. 10, 1999
Bjarklev, Broeng, and Bjarklev Photonic crystal fibres, Kluwer Academic Press, 2003 (chapter 1 and 4)
WO 2005/091029 (Crystal Fibre) Sep. 29, 2005
U.S. Pat. No. 5,907,652 (Lucent Technologies) May 25, 1999
WO 03/019257 (Crystal Fibre) Mar. 6, 2003
WO 2004/049025 (Crystal Fibre) Jun. 10, 2004
Michel. J. F. Digonnet Rare-Earth-Doped Fiber Lasers and Amplifiers, 2^{nd} edition, 2001, Marcel Dekker, Inc. (chapter 3, pp. 113-170.)
L. C. Feldman, J. W. Mayer Fundamentals of surface and thin film analysis. ISBN 0-444-00989-2

1) A waveguide laser or amplifier material comprising
a silica glass host material,
one or more rare earth elements in total concentration c_{RE} at. %,
one or more network modifier elements selected from the group of tri- or penta-valent atoms of the periodic table of the elements in total concentration c_{NME} at. %,
wherein the ratio of atomic concentrations of the modifier elements to that of the rare earth elements c_{NME}/c_{RE} is larger than or equal to 1, and
wherein the total atomic concentration of rare earth and the tri-valent network modifiers is substantially equal to the atomic concentration of the penta-valent network modifier.

2) A waveguide laser or amplifier material according to claim 1 wherein c_{NME}/c_{RE} is larger than 2.

3) A waveguide laser or amplifier material according to claim 1 wherein the network modifier elements are selected from the group of elements comprising aluminum, phosphor, boron, and combinations thereof.

4) A waveguide laser or amplifier material according to according to claim 1 wherein said rare earth doped material comprises elements selected from the group consisting of Tb, Nd, Ho, Dy, Tm, Er and Yb and combinations thereof.

5) A waveguide laser or amplifier material according to according to claim 4 wherein said rare earth dopant is ytterbium.

6) A waveguide laser or amplifier material according to claim 1 further comprising fluorine in concentration c_{F} at. % (mol.).

7) A material according to according to claim 6 wherein c_{F}≧c_{RE}

8) A waveguide laser or amplifier material according to claim 1 wherein the rare earth doping is in a concentration exceeding 0.1.

9) A waveguide laser or amplifier material according to claim 1 wherein said network modifiers comprises boron and phosphorous.

10) A waveguide laser or amplifier material according to claim 1 wherein said network modifiers comprises aluminum and phosphorous.

11) An optical waveguide comprising a waveguide laser or amplifier material according to claim 1.

12) An optical waveguide according to claim 11 comprising a silica host glass with a rare earth doped core said core comprising a waveguide laser or amplifier material according to claim 1.

13) An optical waveguide according to claim 12 wherein the core has a largest dimensions d_{core}, such as a diameter, where dcore≧4 μm.

14) An optical waveguide according to claim 12 wherein the core has a numeric aperture less than or equal to 0.1.

15) An optical waveguide according to claim 12 wherein a first cladding surrounds the core.

16) An optical waveguide according to claim 15 wherein said first cladding is having a largest dimension, such as a diameter, larger than or equal to 30 μm.

17) An optical waveguide according to claim 15 wherein the first cladding has a numeric aperture larger than or equal to 0.4.

18) An optical waveguide according to claim 15 wherein the optical waveguide comprises a second cladding comprising either polymeric material or an air/glass microstructure.

19) An optical waveguide according to claim 11 wherein the optical waveguide is an optical fibre.

20) An optical waveguide according to claim 11 wherein the optical waveguide is a planar waveguide.

21) An optical waveguide according to claim 11 comprising a core region surrounded by two or more cladding regions wherein at least one of said core and cladding regions comprises said waveguide laser or amplifier material and is adapted to guide light at a signal wavelength.

22) An optical waveguide according to claim 21 wherein at least one other of said core and cladding regions is adapted to guide light at a pump wavelength.

23) An optical waveguide according to claim 21 comprising micro-structural elements in one or more of the core and/or cladding regions.

24) An optical waveguide according to claim 23 comprising an air-clad region.

25) An optical waveguide according to claim 11 comprising a polymer cladding region.

26) An optical waveguide according to claim 21 wherein the core region has a maximum cross-sectional dimension larger than 4 μm.

27) An optical waveguide according to claim 21 wherein a first inner cladding region located adjacent to said core region has a numeric aperture larger than or equal to 0.4.

28) An optical amplifier comprising:
a) an optical waveguide according to claim 11,
b) at least one pump laser which is operating at one or more a wavelengths λpump-with a total pump power equal to or exceeding 5 W arranged to pump said optical waveguide wherein the wavelengths λpump are resonant with said rare earth doping absorption band, and
c) an output.

29) An optical amplifier according to claim 28 wherein said pump laser(s) is a multimode source, such as comprising a diode bar array.

30) An optical amplifier according to claim 28 further comprising a coupling device adapted to couple light from said pump laser(s) to the optical waveguide.

31) An optical amplifier according to claim 28 wherein said output is an output delivery fibre.

32 An optical amplifier according to claim 30 wherein said coupling device is a fused fibre bundle.

33) An optical amplifier according to claim 32 wherein said fibre bundle is tapered to fit in a numeric aperture of the optical waveguide.

34) An optical amplifier according to claim 33 wherein said fibre bundle is tapered to fit in a numeric aperture of the first cladding of the optical waveguide.

35) An optical amplifier according to claim 32 wherein the fibre bundle fibres are in optical communication with the pump laser(s), such as attached to a diode bar array.

36) An optical amplifier according to claim 28 further comprising a at least one fibre Bragg grating, such as a first fibre Bragg grating between said coupling device and said optical waveguide and/or a second fibre Bragg grating between said silica host glass fibre and said output.

37) An optical amplifier according to claim 36 where said first and second fibre Bragg grating are formed by fusion splicing a section of fibre wherein the fibre Bragg grating is formed to the respective fibre ends.

38) An optical amplifier according to claim 36 where areas next to said rare earth doped core is doped with germanium and said first and second Bragg gratings are written directly into said areas next to said rare earth doped core.

39) A preform for fabricating an optical fibre comprising a waveguide laser or amplifier material according to claim 1.

40) A preform for fabricating an optical fibre according to claim 39 further comprising any of the features of the optical waveguide of claim 11.

41) An article comprising an optical waveguide according to claim 11.

42) An article according to claim 41 in the form of a fibre laser, an all-fibre laser, a mode-locked laser or an amplifier.

43) An article according to claim 41 comprising a source of pump light comprising wavelengths that are resonant with an absorption band of said one or more rare earth elements.

44) An article according to claim 43 wherein said pump light comprises wavelengths below 1000 nm.

45) An article according to claim 41 adapted to operate at a wavelength below 1100 nm.

46) An article according to claim 41 wherein the input power to output power efficiency degradation after 1000 hours of operation at a population inversion level of at least 15% is less than 10.

47) Use of an article according to claim 41 at an operating wavelength below 1100 nm.

48) A high power amplifier comprising:
a) a diode bar array pump laser which operates at a wavelength λpump and with a pump power exceeding 5 W,
b) a coupling device,
c) a silica host glass fibre with a rare earth doped core co-doped with network modifiers aluminum and/or boron and phosphor in a concentration such that the total atomic network modifier concentration is at least 7 times the rare earth atomic concentration and
d) a silica host glass fibre with a rare earth doped core co-doped with network modifiers aluminum and/or boron and phosphor in a concentration such that the total atomic concentration of rare earth and aluminum and/or boron is substantially equal to the atomic concentration of phosphorous
e) an output delivery fibre
f) wherein the wavelength λpump is resonant with said rare earth doping absorption band

49) A high power amplifier according to claim 48 wherein the rare earth doping is in a concentration exceeding 0.1 atomic percent.

50) A high power amplifier according to claim 48 wherein said rare earth doped material is ytterbium and said network modifiers are aluminum and phosphorous and said network modifier atomic concentration is at least 7 times the ytterbium atomic concentration.

51) A high power amplifier according to claim 48 wherein said rare earth doped material is ytterbium and said network modifiers are boron and phosphorous and said network modifier atomic concentration is at least 7 times the ytterbium atomic concentration.

52) A high power amplifier according to claim 48 wherein said rare earth doped material is selected from the group consisting of Tb, Nd, Ho, Dy, Tm, Er, Yb and combinations thereof, and said network modifiers are aluminum and phosphorous and said network modifier atomic concentration is at least 7 times said rare earth atomic concentration.

53) A high power amplifier according to claim 48 wherein said silica host glass fibre holds a core diameter dcore>4 μm with a numeric aperture less than 0.1, and a first cladding diameter>30 μm with a numeric aperture larger than or equal to 0.4, surrounded by a second cladding comprising either polymeric material or an air/glass microstructure, and wherein said coupling device is a fused fibre bundle tapered to fit in numeric aperture to the numeric aperture of the first cladding and the fibre bundle fibres are attached to diode bar array lasers.

54) A high power amplifier according to claim 48 wherein between said coupling device and said silica host glass fibre is formed a first fibre Bragg grating, and wherein between said silica host glass fibre and said output delivery fibre is formed a second fibre Bragg grating.

55) A high power amplifier according to claim 54 where said first and second fibre Bragg grating are formed by fusion splicing a section of fibre wherein the fibre Bragg grating is formed to the respective fibre ends.

56) A high power amplifier according to claim 54 where areas next to said rare earth doped core is doped with germanium and said first and second Bragg gratings are written directly into said areas next to said rare earth doped core.

57) A waveguide laser or amplifier material comprising
a) a silica glass host material,
b) one or more rare earth elements in total concentration c_{RE} at. % (mol.),
c) one or more network modifier elements selected from the group of tri- or penta-valent atoms of the periodic table of the elements in total concentration c_{NME} at. % (mol.),
wherein the the ratio of atomic concentrations of the modifier elements to that of the rare earth elements c_{NME}/c_{RE} is larger than 5, and
wherein the total atomic concentration of rare earth and the tri-valent network modifiers is substantially equal to the atomic concentration of the penta-valent network modifier.

58) A material according to claim 57 wherein is larger than 6.

59) A material according to claim 57 wherein the network modifier elements are selected from the group of elements comprising aluminum, phosphor, boron, and combinations thereof.

60) A material according to claim 57 wherein said rare earth doped material comprises elements selected from the group consisting of Tb, Nd, Ho, Dy, Tm, Er and Yb and combinations thereof.

61) A material according to claim 57 wherein said rare earth doped material is ytterbium.

62) A material according to claim 57 further comprising fluorine in concentration c_{F} at. % (mol.).

63) A material according to claim 64 wherein c_{F}>c_{RE}.

64) A preform for fabricating an optical fibre comprising a waveguide laser or amplifier material according to claim 57.

65) An optical fibre comprising a waveguide laser or amplifier material according to claim 57.

66) An optical fibre according to claim 65 comprising a core region surrounded by two or more cladding regions wherein at least one of said core and cladding regions comprises said waveguide laser or amplifier material and is adapted to guide light at a signal wavelength.

67) An optical fibre according to claim 66 wherein at least one other of said core and cladding regions is adapted to guide light at a pump wavelength.

68) An optical fibre according to claim 66 comprising micro-structural elements in one or more of the core and/or cladding regions.

69) An optical fibre according to claim 68 comprising an air-clad region.

70) An optical fibre according to claim 65 comprising a polymer cladding region.

71) An optical fibre according to claim 65 wherein the core region has a maximum cross-sectional dimension larger than 4 μm.

72) An optical fibre according to claim 65 wherein a first inner cladding region located adjacent to said core region has a numeric aperture larger than or equal to 0.4.

73) An article comprising an optical fibre according claim 65.

74) An article according to claim 73 in the form of a fibre laser or amplifier.

75) An article according to claim 73 comprising a source of pump light comprising wavelengths that are resonant with an absorption band of said one or more rare earth elements.

76) An article according to claim 75 wherein said pump light comprises wavelengths below 1000 nm.

77) An article according to claims 73 adapted to operate at a wavelength below 1100 nm.

78) An article according to claim 73 wherein the input power to output power efficiency degradation after 1000 hours of operation at a population inversion level of 15% is less than 10%.

79) Use of an article according to claim 73 at an operating wavelength below 1100 nm.
